(19) United States
(12) Patent Application Publication
(10) Pub. No.: US 2005/0149463 A1
(43) Pub. Date: Jul. 7, 2005

(54) Method of training a neural network and a neural network trained according to the method

(76) Inventors: George Bolt, Hampshire (GB); John Manslow, Hampshire (GB); Alan McLachlan, Hampshire (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/976,167

(22) Filed: Oct. 28, 2004

Related U.S. Application Data
(63) Continuation of application No. PCT/AU03/00500, filed on Apr. 29, 2003.

(30) Foreign Application Priority Data
Apr. 29, 2002 (GB) 0209780.6

(51) Int. Cl. G06G 7/00; G06F 15/18

(52) U.S. Cl. 706/20; 706/26

(57) ABSTRACT

A neural network comprises trained interconnected neurons. The neural network is configured to constrain the relationship between one or more inputs and one or more outputs of the neural network so the relationships between them are consistent with expectations of the relationships; and/or the neural network is trained by creating a set of data comprising input data and associated outputs that represent archetypal results and providing real exemplary input data and associated output data and the created data to neural network. The real exemplary output data and the created associated output data is compared to the actual output of the neural network, which is adjusted to create a best fit to the real exemplary data and the created data.

### FIELD OF THE INVENTION

The present invention relates to neural networks and the training thereof

### BACKGROUND OF THE INVENTION

Scorecards are commonly used by a wide variety of credit-issuing businesses to assess the credit worthiness of potential clients. For example, suppliers of domestic utilities examine the credit worthiness of consumers because payments for the services they supply are usually made in arrears, and hence the services themselves constitute a form of credit. Banks and credit card issuers, both of which issue credit explicitly, do likewise in order to minimise the amount of bad debt—the proportion of credit issued that cannot be recovered. Businesses that are involved in issuing credit are engaged in a highly competitive market where profitability often depends on exploiting marginal cases—that is, those where it is difficult to predict whether a default on credit repayments will occur. This has led to many businesses replacing their traditional hand-crafted scorecards with neural networks. Neural networks are able to learn the relationship between the details of specific customers—their address, their age, their length of employment in their current job, etc. and the probability that they will default on credit repayments, provided that they are given enough examples of good and bad debtors (people who do, and do not repay).

In the business world more generally, credit is routinely issued in the interactions between businesses, where goods and services are provided on the promise to pay at some later date. Such credit issues tend to be higher risk than those aimed directly at the public, because they tend to be smaller in number, and each is greater in value. Any individual default therefore has a proportionally greater impact on the finances of the credit issuer. To minimise these risks, businesses frequently use scorecards, and more recently, neural networks, to assess the credit worthiness of potential debtors. Whereas businesses that issue credit to members of the general public frequently have a large number of example credit issues and known outcomes (e.g. prompt payment, late payment, default, etc.), issuers of credit to businesses often only have information on fewer than a hundred other businesses. Training neural networks on such small sets of examples can be hazardous because they are likely to overfit—that is, to learn features of the particular set of examples that are not representative of businesses in general—with the result that their credit score estimates are likely to be poor.

For example, one business in the set of examples may have performed exceptionally poorly for the period to which the example data applies as a result of a random confluence of factors that is not likely to recur. This could result in a neural network that consistently underestimates the credit worthiness of similar businesses, resulting in an over-cautious policy with respect to such businesses, and hence opportunities lost to competitors.

### SUMMARY OF THE PRESENT INVENTION

In accordance with a first aspect of the invention there is provided a neural network comprising:
trained interconnected neurons,
wherein one or more neurons produce a numeric preliminary output, the preliminary output being manipulated to produce a final output;
wherein during training of the neural network each possible non-numeric final output is numerically encoded into a training preliminary output such that the uniqueness and adjacency relations between each non-numeric final output is preserved;
whereby, in use, the preliminary output is converted to an estimated non-numeric final output.

In one embodiment, the preliminary output comprises one or more scalars, wherein the final output is based on the nearest numerically encoded equivalent final output used in training the neural network.

In another embodiment, the preliminary output is a probability density over the range of possible network outputs. Preferably the probability density is decoded by computing the probability of each category from the proportion of the probability mass that lies within the range of each rating, where the range of a rating is defined as all values of the output that are closer to the encoded rating than any other.

In accordance with a second aspect of the invention there is provided a method of training a neural network for improved robustness when only small sets of examples are available for training, said method comprising at least the steps of:
creating a set of data comprising input data and associated outputs that represent archetypal results; and
providing real exemplary input data and associated output data and the created data to the neural network;
comparing real exemplary output data and the created associated output data to the actual output of the neural network;
adjusting the neural network to create a best fit to the real exemplary data and the created data. The term best fit is to be construed according to standard neural network training practices.

In accordance with a third aspect of the invention there is provided a method of training a neural network for improved robustness when only small sets of examples are available for training, said method comprising at least the steps of:
constraining the relationship between one or more inputs and one or more outputs of the neural network so that the relationship is consistent with an expected relationship between said one or more inputs and said one or more outputs.

Preferably the constraint on the relationship that must be satisfied is based on prior knowledge of the relationships between certain inputs and the outputs desired of the neural network.

Preferably the constraint is such that when a certain input changes the output must monotonically change.

Preferably the neural network being trained has one or more neurons with monotonic activation functions and the signs of the weights of the connections between a layer of input neurons, one or more layers of hidden neurons and a layer of output neurons determines whether the neural network output is positively or negatively monotonic with respect to each input.

Preferably, each monotonicitally constrained weight is redefined as a positive function of a dummy weight where the weights are to have positive values. Preferably, each monotonicitally constrained weight is redefined as a negative function of a dummy weight where the weights are to have negative values. A positive function is here defined as a function that returns positive values for all values of its argument, and a negative function is defined as one that return negative values for all values of its argument.

Preferably the positive function used to derive the constrained weights from the dummy weights, is the exponential function. Preferably the negative function used to derive the constrained weights from the dummy weights is minus one times the exponential function.

Preferably the neural network is trained by applying a standard unconstrained optimisation technique that is used for training simultaneously all weights that do not need to be constrained and the dummy weights.

Preferably the neural network's unconstrained weights and dummy weights are initialised using a standard weight initialisation procedure. Preferably the neural network's constrained weights are computed from their dummy weights, and the neural network's performance measured on example data

Preferably the performance measurement is carried out by presenting example data to the inputs of the neural network, and measuring the difference/error between the result output by the neural network and the example result corresponding to the example input data. Typically the squared difference between these values is used. Alternatively other standard difference/error measures are used. The sum of the differences for each data example provides a measure of the neural network's performance.

Preferably a perturbation technique is used to adjust the values of the weights to fit the best fit to the exemplary data. Preferably the values of all unconstrained weights, and all dummy weights are then perturbed by adding random numbers to them, and new values of the constrained weights are derived from the dummy weights. The network's performance with its new weights is then assessed, and, if its performance has not improved, the old values of the unconstrained weights and dummy weights are restored, and the perturbation process repeated. If the network's performance did improve, but is not yet satisfactory the perturbation process is also repeated. Otherwise, training is complete, and all the network's weights—constrained and unconstrained—are fixed at their present values. The dummy weights and the functions used to derive constrained weights are then deleted.

Alterative standard neural network training algorithms can be used in place of a perturbation search, such as backpropagation gradient descent, conjugate gradients, scaled conjugate gradients, Levenberg-Marquardt, Newton, quasi-Newton, Ouickprop, R-prop, etc.

The neural network may be used to estimate business credit scores as any other network would, without special consideration as to which weights were constrained and unconstrained during training.

In accordance with a fourth aspect of the invention there is provided a neural network comprising:
a plurality of inputs and one or more outputs which produce an output dependant on data received by the input according to training of interconnections between the input, hidden neurons and the outputs;
wherein interconnections are trained such that the relationship between the inputs and the outputs of the neural network is constrained, according to expectations of the relationship between the inputs and the outputs.

Preferably the neurons have monotonic activation functions. Preferably the interconnected neurons include a layer of input neurons, one or more layers of hidden neurons and a layer of output neurons. Preferably, input neurons are not connected to the same hidden neurons where it is known that certain inputs are to affect the output of the network independently.

Preferably the weights between all hidden neurons and the output neurons that are connected directly to an input of a subset of at least one output neuron for which monotonicity is required, are of the same sign. Preferably the weights between each input neuron and all hidden neurons that are connected directly to an input of the subset of are of the same sign.

Preferably the sign of the weights between the input neurons and the hidden neurons determines whether the neural network output is positively or negatively monotonic with respect to each input.

Preferably the neural network is one of the group comprising, a multilayer perceptron, support vector machine, and related techniques (such as the relevance vector machine), or regression-oriented machine learning techniques.

Preferably the neural network is a Bayesian neural network, where a posterior probability density over the neural network's weights is the result of training.

Preferably the posterior probability density is used to provide an indication of how consistent different combinations of values of the weights are with the information in the training samples and the prior probability density. Preferably prior knowledge about which combinations of weight values are likely to produce networks that produce good credit score estimates is used by expressing the prior knowledge as a prior probability density over the values of the neural network's weights. Preferably the prior probability density is chosen to be a Gaussian distribution centred at the point where all weights are zero.

Preferably the additional prior knowledge that certain weights must either be positive or negative by setting the prior probability density to zero for any combination of weight values that violate the constraints required to impose the desired monotonicity constraints.

In accordance with a fifth aspect of the invention there is provided a method of training a neural network having one or more outputs representing non-numeric values and when only small sets of examples are available for training, comprising at least the steps of:
numerically encoding each non-numeric output such that the uniqueness and adjacency relationships between each non-numeric output is preserved;
constraining the relationship between one or more inputs and one or more outputs so that the relationship between them is consistent with an expected relationship between said one or more inputs and said one or more outputs;
creating a set of data comprising input data and associated outputs that represent archetypal results;
providing real exemplary input data and associated output data and the created data to the neural network;
comparing real exemplary output data and the created associated output data to the actual output of the neural network; and
adjusting the neural network to create a best fit to the real exemplary data and the created data.

In accordance with a sixth aspect of the invention there is provided a neural network comprising:
a plurality of inputs and one or more outputs which produce an output dependant on data received by the input according to training of interconnections between the inputs, hidden neurons and the outputs;
wherein interconnections are trained such that the relationship between the inputs and the outputs is constrained according to the expectations of the relationship between the inputs and the outputs;
wherein one or more output neurons produce a numeric preliminary output, the preliminary output being manipulated to produce a final output;
wherein during training of the neural network each possible non-numeric final output is numerically encoded into a training preliminary output such that the uniqueness and adjacency relations between each non-numeric final output is preserved;
whereby, in use, the preliminary output is converted to an estimated non-numeric final output based on the nearest numerically encoded equivalent final output used in training the neural network.

### BRIEF DESCRIPTION OF THE DRAWINGS

In order to provide a better understanding of the nature of the invention, preferred embodiments will now be described in greater detail, by way of example only, with reference to the accompanying drawings in which:

FIG. 1 is a diagram of a probability density distribution produced by a Bayesian multi layer perceptron neural network;

FIG. 2 is a decoded distribution finding categories based on the distribution in FIG. 1;

FIG. 3 is an example of a neural network;

FIG. 4 is an example of part of the neural network of FIG. 3 having constraints according to the present invention; and

FIG. 5 is a flow diagram showing an example of a method training a neural network according to the present invention.

### DETAILED DESCRIPTION OF PREFERRED EMBODIMENTS

An example of a neural network 10 is shown in FIG. 3 which includes a layer 12 of input neurons 14, a layer 16 of hidden neurons 18 and an output layer 20 with output neurons 22. Each of the neurons is interconnected with each of the neurons in the adjacent layer. That is, each of the input neurons 14 is connected to each of the neurons 18 in the hidden layer 16 and each of the hidden neurons 18 in the hidden layer 16 is connected to each of the output neurons 22 in the output layer 20. Each of the input neurons receives an input and each of the output neurons 22 provides an output based on the trained relationship between each of the neurons. The relationship is defined according to a weight provided to each of the connections between each of the neurons. It will be appreciated by the skilled addressee that more than one hidden layer 16 of hidden neurons 18 may be provided. The lines between each neuron represent the weighted connection between the neurons. The neural network may be of the following standard types: a multi layer perception, a support vector machine, and related techniques (such as the relevance vector machine) or regression-oriented machine learning techniques.

The present invention uses the example of determining a credit worthiness rating from data describing a business (for example, it's turnover, the value of it's sales, the value of it's debts, the value of it's assets, etc.) to demonstrate the usefulness of the present invention. However it will be appreciated that the present invention may be provided to many other expert systems.

To train a neural network, numerous examples of the relationship between input data and outputs of the neural network must be provided so that through the course of providing each of these examples, the neural network learns the relationship in terms of the weighting applied to each of the connections between each of the neurons of the neural network.

To teach a neural network the relationship between data that describes a business and its credit worthiness, a number of examples of businesses for which both these data and the credit scores are known must be available. To create these examples, data from a number of businesses are collected, and the businesses are rated manually by a team of credit analysts. It could be suggested that training a neural network or manually produce credit scores could cause the network to inherit all of the faults of the experts themselves (such as the tendency to consistently underrate or overrate particular companies based on personal preconceptions). In practice, however, the trained network will show the same faults as the experts in a highly diluted form, if at all, and will often perform better, on average than the experts themselves because of it's consistency.

The ratings produced by credit analysts traditionally take the form of ordered string-based categories, as shown in table 1. The highest rated (most credit-worthy) businesses are given the rating at the top of the table, while the lowest rated (least credit-worthy) are given the rating at the bottom of the table. Since neural networks can only process numeric data directly, the string-based categories need to be converted into numbers before the neural network can be trained. Similarly, once trained, the neural network outputs estimates of business's credit-worthiness in the encoded, numeric form, which must be translated back into the string-based format for human interpretation. The encoding process involves converting the categories to numbers that preserve the uniqueness and adjacency relations between them.

TABLE 1

| Ordered Credit | | | |
|---|---|---|---|
| Scores (most credit- | Legal | Legal | Illegal |
| worthy first) | Encoding 1 | Encoding 2 | Encoding |
| A1 | 1 | −100 | 1 |
| A2 | 2 | −120 | 2 |
| A3 | 3 | −140 | 7 |
| A4 | 4 | −160 | 3 |
| A5 | 5 | −180 | 4 |
| B1 | 6 | −200 | 5 |
| B2 | 7 | −220 | 6 |
| B3 | 8 | −240 | 8 |
| B4 | 9 | −260 | 12 |
| B5 | 10 | −280 | 9 |
| C1 | 11 | −300 | 10 |
| C2 | 12 | −320 | 11 |
| C3 | 13 | −340 | 13 |
| C4 | 14 | −360 | 14 |
| C5 | 15 | −380 | 15 |
| D1 | 16 | −400 | 16 |
| D2 | 17 | −420 | 32 |
| D3 | 18 | −440 | 17 |
| D4 | 19 | −460 | 20 |
| D5 | 20 | −480 | 18 |
| X | 21 | −500 | 20 |
| U | 22 | −520 | 21 |

For example, string-based categories that are adjacent (e.g., A5 and B1) must result in numeric equivalents that are also adjacent, and each unique category must be encoded as a unique number. Examples of suitable numeric encodings of the categories are given in the second and third columns of table 1, along with an unsuitable encoding that violates both the uniqueness and adjacency requirements in column 4. The spacing between the encoded categories can also be adjusted to reflect variations in the conceptual spacing between the categories themselves. For example, in a rating system with categories A, B, C, D, and E, the conceptual difference between a rating of A and B may be greater than between B and C. This could be reflected in the encoding of these categories by spacing the encoded values for A and B further apart than those for B and C, leading to a coding of, for example, A→10, B→5, C→4 (where ‘→’ has been used as shorthand for ‘is encoded as’). This can be used to reduce the relative rate at which the neural network will confuse businesses that should be rated A or B, as compared to those rated B or C.

Ratings estimated by a neural network with the coding scheme just described can be converted back into the human-readable string-based form by converting them into the string with the nearest numerically encoded equivalent. For example, assuming that the string-based categories are encoded as shown in column 2 of table 1, an output of 2.2 would be decoded to be A2. More complex decoding is also possible, particularly with neural networks that provide more than a single output For example, some neural networks (such as a Bayesian multilayer perceptron based on a Laplace approximation) provide a most probable output with error bars. This information can be translated into string-based categories using the above method, to produce a most probable credit score, along with a range of likely alternative credit scores. For example,. assuming that the categories are encoded as shown in column 2 of table 1, a most probable output of 2.2 with error bars of ±7 would be translated into a most probable category of A2 with range of likely alternatives of A1 to A4.

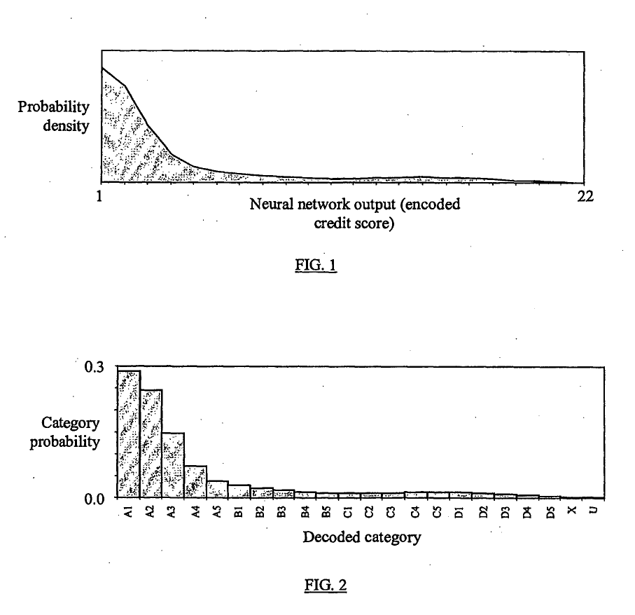

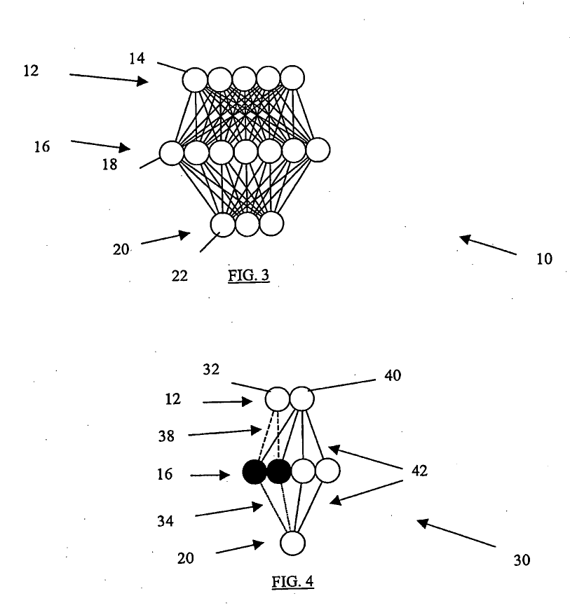

Finally, some neural networks (such as some Bayesian multiplayer perceptrons that do not use a Laplace approximation) do not produce a finite set of outputs at all, but rather produce a probability density over the range of possible network outputs, as shown in FIG. 1. This type of output can be decoded by computing the probability of each category from the proportion of the probability mass that lies within the range of each category, where the range of a category is defined as all values of the output that are closer to the encoded category than any other. An example of this type of decoding is shown in FIG. 2. More complex ways of determining the ranges associated with individual categories can also be considered, and may be more appropriate when the spaces between the encoded categories vary dramatically. For example, for the purposes of decoding, each category may have an upper and lower range associated with it, and all encoded values within a category's range are decoded to it. Using the categories A to E from the example that was introduced earlier, category A could be associated with the range 9.5 to 10.5, B with 4.5 to 9.5, etc. This allows the range of encoded network outputs decoded into each category to be controlled independently of the spacing between the categories, and is useful when, as in this example, two categories (A and B) need to be widely separated, but one of the categories (A, corresponding to exceptionally credit-worthy businesses) needs to be kept as small as possible.

The present invention provides two separate techniques for improving the performance of neural network credit scoring systems trained on limited quantities of data. The first involves adding artificial data to the real examples that are used to train the neural network. These artificial data consist of fake business data and associated credit scores, and are manually constructed by credit analysts to represent businesses that are archetypal for their score. The artificial data represent ‘soft’ constraints on the trained neural network (‘soft’ meaning that they don't have to be satisfied exactly—i.e. the trained neural network does not have to reproduce the credit scores of the artificial (or, for that matter, real) data exactly), and help to ensure that the neural network rates businesses according to the credit analysts' expectations—particularly for extreme ratings where there may be few real examples. The second method of improving performance relies on allowing credit analysts to incorporate some of the prior knowledge that they have as to necessary relationships between the business data that is input to the credit scoring neural network, and the credit score that it should produce in response. For example, when the value of the debt of a business decreases (and all of the other details remain unchanged), its credit score should increase. That is to say that the output of the neural network should be negatively monotonic with respect to changes in its ‘value of debt’ input. Adding this ‘hard’ constraint (‘hard’ in the sense that it must be satisfied by the trained network) also helps to guarantee that the ratings produced by the neural network satisfy basic properties that the credit analysts know should always apply.

Guaranteeing monotonicity in practice is difficult with neural networks, which are typically designed to find the best fit to the example data regardless of monotonicity. The credit scoring neural network described in this invention has the structure shown in FIG. 3, where all neurons have monotonic activation functions (an activation function is the non-linear transformation that a neuron applies to the information it receives in order to compute its level of activity). For example, the activity of a hidden neuron only either increases or decreases in response to an increase in the activity of each of the input neurons, depending on the sign of the weight that connects them. Similarly, the activity of an output neuron either increases or decreases in response to an increase in the activity of each of the hidden neurons to which it is connected, depending on the sign of the weight between them.

Note that the number of input, hidden, and output neurons, and hidden layers can vary, as can the connectivity. In FIG. 3, every neuron in every layer is connected to every neuron in each adjacent layer, whereas, in some applications, some connections may be missing. For example, if it is known that certain pairs of inputs should affect the output of the network independently, the network can be forced to guarantee this by ensuring that the pair are never connected to the same hidden neurons. If a neural network has a structure similar to that shown in FIG. 3 (where ‘similar’ includes those with a varying number of neurons in each layer, numbers of layers, and connectivity, as just described), and consists only of neurons with monotonic activation functions, the monotonicity of its output with respect to any subset of its inputs can be guaranteed by ensuring that the weights between all hidden neurons that are connected directly to at least one input in the subset, and the output, are of the same sign, and that all weights from each input in the subset to the hidden neurons are of the same sign. Whether these weights (between the input and hidden neurons) are positive or negative determines whether the network output is positively or negatively monotonic with respect to each input.

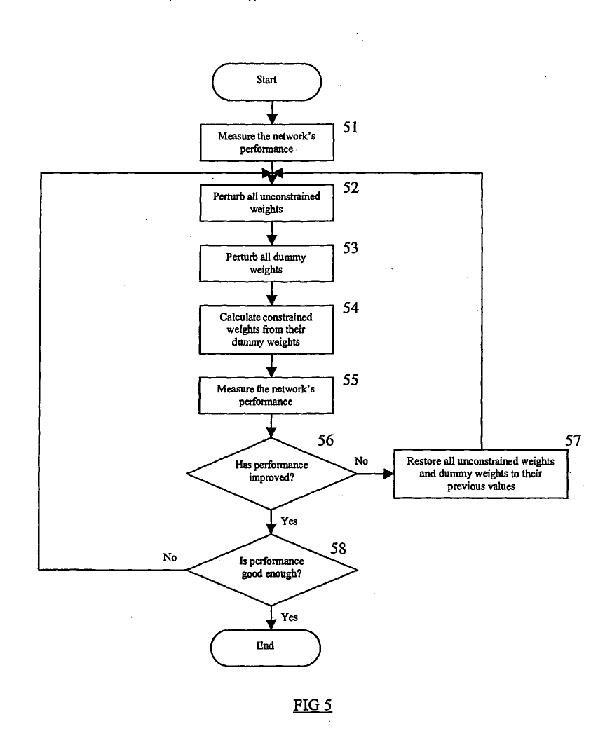

To illustrate these ideas, FIG. 4 shows a network 30 (or part of a larger network) where monotonicity is required with respect to only the first input 32 to the network. The output can change in any way with respect to the input received at input neuron 40. The hidden-to-output layer weights that must be constrained are shown as dotted lines 34, the hidden neurons 36 that are connected to the input for which the constraint must apply are shown as filled black circles, and the input-to-hidden layer weights 38 that must be constrained are shown as dashed lines. Solid line connection weights 42 need not be constrained. To guarantee monotonicity, all weights 34 shown as dotted lines must have the same sign, and all weights shown as dashed lines 38 must have the same sign. To guarantee positive monotonicity (so that the output always increases with an increase in the first input), all weights shown as dashed lines 38 must be positive, and all weights shown as dotted lines 34 be positive (assuming the activation functions are positively monotonic). To guarantee negative monotonicity (so that the output always decreases with an increase in the first input), all weights shown as dashed lines 38 must be negative, and all weights shown as dotted lines 34 must be positive (again, assuming the activation functions are positively monotonic). In this way, the output of a neural network similar to that of FIG. 3 (where ‘similar’ is assumed to have the same meaning as in the previous paragraph) can be guaranteed to be either positively or negatively monotonic with respect to each of its inputs, or unconstrained. (Note that, in a network of the type shown, negative monotonicity is guaranteed as long as the dashed and dotted weights are of opposite sign.)

To train a neural network with these constraints on its weights can be difficult in practice, since the standard textbook neural network training algorithms (such as gradient descent) are designed for unconstrained optimisation, meaning that the weights they produce can be positive or negative.

One way of constraining the neural network weights to ensure monotonicity is to develop a new type of training procedure (none of the standard types allow for the incorporation of the constraints required to guarantee monotonicity). This is a time consuming and costly exercise, and hence not attractive in practice. The constrained optimisation algorithms that would have to be adapted for this purpose tend to be more complex and less efficient than their unconstrained counterparts, meaning that, even once a new training algorithm had been designed, its implementation and use in developing neural network scorecards would be time consuming and expensive.

Another way of constraining the neural network weights to ensure monotonicity, according to a preferred form of the present invention is to let each weight, w, that needs to be constrained, can be redefined as a positive (or negative) function of a dummy weight, w*. (Positive functions are positive for all values of their arguments, and can be used to constrain weights to have positive values, while negative functions are negative for all values of their arguments, and can be used to constrain weights to negative values.) Once this has been done, the network can be trained by applying one of the standard unconstrained optimisation techniques that are used for training simultaneously all weights that do not need to be constrained and the dummy weights. Almost any positive (or negative) function can be used to derive the constrained weights from the dummy weights, but the exponential, w=exp(w*) has been found to work well in practice. In the case of a negative function −exp(w*) can be used. It will be appreciated that other suitable functions could also be used. This method of producing monotonicity is particularly convenient, because the standard neural network training algorithms can be applied unmodified, making training fast and efficient.

As an example, consider training a neural network using a simple training algorithm called a perturbation search. A perturbation search operates by measuring the performance of the network on the example data, perturbing each of the network's weights by adding a small random number to them, and re-measuring the performance of the network. If its performance deteriorated, the network's weights are restored to their previous values. These steps are repeated until satisfactory performance is achieved. FIG. 5 shows a flowchart of how the perturbation search can be used to train a network that has some or all of its weights constrained through the use of dummy weights, as was described in the previous paragraph. Firstly, (not shown in FIG. 5) the network's unconstrained weights and dummy weights are initialised using one of the standard weight initialisation procedures (such as setting them to random values in the interval [−1,1]). Next, the network's constrained weights are computed from their dummy weights, as described in the preceding paragraph, and the network's performance measured 51 on the example data.

The performance assessment is carried out by presenting the details of each business in the example data to the network, and measuring the difference/error between the credit score estimated by the network and the credit score of the business in the example data. The squared difference between these values is usually used, though any of the standard difference/error measures (such as the Minkowsi-R family, for example) are also suitable. The sum of the differences for each business in the example data provides a measure of the network's performance at estimating the credit scores of the businesses in the sample. The values of all unconstrained weights, and all dummy weights are then perturbed (52 and 53) by adding random numbers to them (for example, chosen from the interval [−0.1, +0.1]), and new values of the constrained weights derived 54 from the dummy weights. The network's performance with its new weights is then assessed 55, and, if at 56 its performance has not improved, the old values of the unconstrained weights and dummy weights are restored 57, and the perturbation process repeated.

If the network's performance did improve, an assessment is made as to whether the performance is satisfactory at 58. If it is not yet satisfactory the perturbation process is also repeated, by returning to step 52. Otherwise, training is complete, and all the network's weights—constrained and unconstrained—are fixed at their present values. The dummy weights and the functions used to derive constrained weights from them are not required once training is complete and can safely be deleted. The neural network can then be used to estimate credit scores as any other network would, without special consideration as to which weights were constrained and unconstrained during training. This example has, for clarity, described how the network can be trained using a simple perturbation search. All the standard neural network training algorithms (such as backpropagation gradient descent, conjugate gradients, scaled conjugate gradients, Levenberg-Marquardt, Newton, quasi-Newton, Quickprop, R-prop, etc.) can also be used, however.

Yet another way of constraining the neural network weights to ensure monotonicitiy, according to another preferred form of the present invention can be used with Bayesian neural networks. Whereas the result of training a normal (non-Bayesian) neural network is a single set of ‘optimal’ values for the network's weights, the result of training a Bayesian network is a posterior probability density over the network's weights. This probability density provides an indication of how consistent different combinations of values of the weights are with the information in the training samples, and with prior knowledge about which combinations of weight values are likely to produce networks that produce good credit score estimates. This prior knowledge must be expressed as a prior probability density over the values of the network's weights, and is usually chosen to be a Gaussian distribution centred at the point where all weights are zero, and reflects the knowledge that, when only small numbers of examples are available for training, networks with weights that are smaller in magnitude tend, on average, to produce better credit score estimates than those with weights that are larger in magnitude.

The additional prior knowledge that needs to be incorporated in order to guarantee the required monotonicity constraints—that certain weights must either be positive or negative—can easily be incorporated into the prior over the values of weights, by setting the prior to zero for any combination of weight values that violate the constraints. For example, if a network with the structure shown in FIG. 4 is used, and, as in the example given earlier, is required to be positively monotonic with respect to the first input, the weights shown as dashed and dotted lines in FIG. 4 need to be positive. Within a Bayesian implementation of the network, this monotonicity constraint could be imposed by forcing the prior density over the weight values to zero everywhere where any of the weights shown as dashed or dotted lines in FIG. 4 are non-positive.

The skilled addressee will realise that the present invention provides advantages over network training techniques of the prior art because the present invention can be used where it is useful to a neural network even though insufficient example data may be available to train a neural network according to traditional techniques. The present invention also allows the use of constraints in the neural network in the use of traditional training techniques that are not normally suitable when constraints are imposed.

Modifications and variations may be made to the present invention without departing from the basic inventive concept. Such modifications and variations are intended to fall within the scope of the present invention, the nature of which is to be determined from the foregoing description.

1. A method of training a neural network having one or more outputs, each output representing numeric or non-numeric values and when only small sets of examples are available for training, the method comprising:
numerically encoding each non-numeric value such that the uniqueness and adjacency relationships between them are preserved;
constraining the relationship between one or more inputs and one or more outputs that the neural network learns so that it is consistent with an expected relationship between the one or more inputs and the one or more outputs;
creating a set of data comprising input data and associated outputs that represent archetypal results;
providing real exemplary input data and associated output data and the created data to the neural network;
comparing real exemplary output data and the created associated output data to the actual output of the neural network; and
adjusting the neural network to create a best fit to the real exemplary data and the created data.

2. A neural network, comprising:
a plurality of inputs and one or more outputs which produce an output dependant on data received by the input according to training of interconnections between the inputs, hidden neurons and the outputs,
wherein interconnections are trained such that the relationship between the inputs and the outputs is constrained according to the expectations of the relationship between the inputs and the outputs,
wherein one or more output neurons produce a numeric preliminary output, the preliminary output being manipulated to produce a final output,
wherein during training of the neural network each possible non-numeric final output is numerically encoded into a training preliminary output such that the uniqueness and adjacency relations between each non-numeric final output value is preserved, and
wherein, in use, the preliminary output is converted to an estimated nonnumeric final output based on the nearest numerically encoded equivalent final output used in training the neural network.

3. A neural network, comprising:
trained interconnected neurons,
wherein one or more neurons produce a numeric preliminary output, the preliminary output being manipulated to produce a final output,
wherein during training of the neural network each possible non-numeric final output is numerically encoded into a training preliminary output such that the uniqueness and adjacency relations between each non-numeric final output are preserved, and
wherein, in use, the preliminary output is converted to an estimated nonnumeric final output.

4. A neural network according to claim 3, wherein the preliminary output comprises one or more scalars, and wherein the final output is based on the nearest numerically encoded equivalent final output used in training the neural network.

5. A neural network according to claim 3, wherein the preliminary output is a probability density over the range of possible network outputs.

6. A neural network according to claim 5, wherein the probability density is decoded by computing the probability of each category from the proportion of the probability mass that lies within the range of each rating, and wherein the range of a rating is defined as all values of the output that are closer to the encoded rating than any other.

7. A method of training a neural network for improved robustness when only small sets of examples are available for training, the method comprising:
creating a set of data comprising input data and associated outputs that represent archetypal results;
providing real exemplary input data and associated output data and the created data to the neural network;
comparing real exemplary output data and the created associated output data to the actual output of the neural network; and
adjusting the neural network to create a best fit to the real exemplary data and the created data.

8. A method of training a neural network for improved robustness when only small sets of examples are available for training, the method comprising:
constraining the relationship between one or more inputs and one or more outputs of the neural network so that the relationship is consistent with an expected relationship between the one or more inputs and the one or more outputs.

9. A method according to claim 8, wherein the constraint on the relationship to be satisfied is based on prior knowledge of the relationships between certain inputs and the outputs desired of the neural network.

10. A method according to claim 8, wherein the constraint is such that when a certain input changes the output monotonically changes.

11. A method according to claim 8, wherein the neural network being trained has one or more neurons with monotonic activation functions and the signs of the weights of the connections between a layer of input neurons, one or more layers of hidden neurons and a layer of output neurons determines whether the neural network output is positively or negatively monotonic with respect to each input.

12. A method according to claim 11, wherein the signs of the weights connecting two or more neurons are fixed by defining the weights in terms of positive functions of one or more dummy weights.

13. A method according to claim 11, wherein the signs of the weights connecting two or more neurons are fixed by defining the weights in terms of negative functions of one or more dummy weights.

14. A method according to claim 11, wherein the positive functions, used to derive the constrained weights from the dummy weights, include an exponential function.

15. A method according to claim 13, wherein the negative functions, used to derive the constrained weights from the dummy weights, are minus one times an exponential function.

16. A method according to either claim 12, wherein the neural network is trained by applying a standard unconstrained optimization technique that is used for training simultaneously all weights that do not need to be constrained and the dummy weights.

17. A method according to claim 16, wherein the neural network's constrained weights are computed from their dummy weights.

18. A method according to claim 12, wherein the neural network may be used to estimate business credit scores as any other network would, without special consideration as to which weights were constrained and unconstrained during training.

19. A neural network, comprising:
a plurality of inputs and one or more outputs which produce an output dependant on data received by the input according to training of interconnections between the input, hidden neurons and the outputs,
wherein interconnections are trained such that the relationship between the inputs and the outputs of the neural network is constrained, according to expectations of the relationship between the inputs and the outputs.

20. A neural network according to claim 19, wherein one or more of the neurons have monotonic activation functions determined by prior knowledge of the relationships between certain inputs and certain outputs of the neural network.

21. A neural network according to claim 20, wherein the interconnected neurons include a layer of input neurons, one or more layers of hidden neurons and a layer of output neurons, and wherein certain input neurons are not connected to the same hidden neurons where it is known that certain inputs are to affect the output of the network independently.

22. A neural network according to claim 20, wherein the interconnected neurons include a layer of input neurons, one or more layers of hidden neurons, and a layer of output neurons, and wherein the weights between the hidden neurons and the output neurons that directly or indirectly lie between an output that must change monotonically with respect to one or more inputs, are of the same sign.

23. A neural network according to claim 22, wherein the weights between each input neuron and all hidden neurons that are connected directly or indirectly to an output that change monotonically with the input are of the same sign.

24. A neural network according to claim 22, wherein the sign of the weights between the input layer and the hidden layer determine whether the neural network output is positively or negatively monotonic with respect to each input.

25. A neural network according to claim 24, wherein the neural network is a Bayesian neural network, where a posterior probability density over the neural network's weights is the result of training.

26. A neural network according to claim 25, wherein the posterior probability density is used to provide an indication of how consistent different combinations of values of the weights are with the information in the training samples and the prior probability density.

27. A neural network according to claim 26, wherein prior knowledge about which combinations of weight values are likely to produce networks that produce good credit score estimates is used by expressing the prior knowledge as a prior probability density over the values of the neural network's weights.

28. A neural network according to claim 27, wherein the prior probability density is chosen to be a Gaussian distribution centered at the point where all weights are zero.

29. A neural network according to claim 28, wherein the additional prior knowledge that certain weights are either positive or negative, by setting the prior probability density to zero for any combination of weight values that violate the constraints required to impose the desired monotonicity constraints.

30. A method of training a neural network when only small sets of examples are available for training, the comprising:
constraining the relationship between one or more inputs and one or more outputs so that the relationship between them is consistent with an expected relationship between the one or more inputs and the one or more outputs;
creating a set of data comprising input data and associated outputs that represent archetypal results;
providing real exemplary input data and associated output data and the created data to the neural network;
comparing real exemplary output data and the created associated output data to the actual output of the neural network; and
adjusting the neural network to create a best fit to the real exemplary data and the created data, where the best fit is determined in accordance with normal neural network training practice.

31. A system for training a neural network having one or more outputs, each output representing numeric or non-numeric values and when only small sets of examples are available for training, the system comprising:
means for numerically encoding each non-numeric value such that the uniqueness and adjacency relationships between them are preserved;
means for constraining the relationship between one or more inputs and one or more outputs that the neural network learns so that it is consistent with an expected relationship between the one or more inputs and the one or more outputs;
means for creating a set of data comprising input data and associated outputs that represent archetypal results;
means for providing real exemplary input data and associated output data and the created data to the neural network;
means for comparing real exemplary output data and the created associated output data to the actual output of the neural network; and
means for adjusting the neural network to create a ‘best fit’ to the real exemplary data and the created data.
